(19) United States
(12) Patent Application Publication
(10) Pub. No.: US 2011/0165354 A1
(43) Pub. Date: Jul. 7, 2011

(54) PENETRATION-RESISTANT ARTICLE

(75) Inventors: Christian Bottger, Remscheid (DE); Jutta Meier, Wuppertal (DE)

(73) Assignee: TEIJIN ARAMID GMBH, Wuppertal (DE)

(21) Appl. No.: 13/063,279

(22) PCT Filed: Sep. 2, 2009
(86) PCT No.: PCT/EP09/61338

§ 371 Date: Mar. 10, 2011

(30) Foreign Application Priority Data
Sep. 10, 2008 (EP) 08164023.7

(51) Int. Cl. B32B 1/06; B32B 1/02

(52) U.S. Cl. 428/36.1; 428/34.1

(57) ABSTRACT

A penetration-resistant article is proposed, which has at least one package of laminates made from at least one layer comprising fibers with a tenacity of at least 2000 MPa according to ASTM D-885. The laminates have further at least one polymeric material, and the at least one package is enclosed by a first separate protective sheath and is essentially completely enclosed by a second separate sheath. The second separate sheath is thereby knitted as one-piece or multiple pieces.

The invention relates to a penetration-resistant article comprising at least one package of laminates made from at least one layer comprising fibers with a tenacity of at least 2000 MPa according to ASTM D-885 and at least one polymeric material, wherein the at least one package is enclosed by a first separate protective sheath.

Penetration-resistant articles comprising laminates made from fibers in a polymeric material are generally known. For example, document WO 99/21446 A2 discloses a ballistic resistant protective garment comprising a plurality of fibers which are embedded in a polymeric material. The superimposed laminates can be provided with a woven sheath, for example made from nylon or polyester fibers.

For penetration-resistant articles of this type, there is, however, a risk of an exit of the projectile at the edge, which is particularly high for an angle shot at the penetration-resistant article. A projectile, which has already been slowed down by penetrating the laminates, namely slides across the relatively smooth laminates and exits at the edge if it has too little energy to penetrate further laminates. A projectile exiting in the periphery of the antiballistically effective package not only presents a risk of injury for the person who is wearing the penetration-resistant article, but also for persons who are in close proximity to the wearer.

The present invention therefore has the object of providing a penetration-resistant article of the type mentioned in the opening paragraph, in which this disadvantage of the prior art is eliminated or at least reduced.

The object is solved by a penetration-resistant article comprising at least one package of laminates made from at least one layer comprising fibers with a tenacity of at least 2000 MPa according to ASTM D-885 and at least one polymeric material, wherein the at least one package is enclosed by a first separate protective sheath and further the at least one package is essentially completely enclosed by a second separate sheath which is knitted as one-piece or multiple pieces.

A penetration-resistant article should be understood as an article that has projectile-resistance and/or stab-resistance properties.

The term “fiber” should be understood as an elongated body whose longitudinal dimension is much larger than its transversal dimensions width and gauge. The term “fiber” correspondingly comprises monofilaments, multifilaments, tape, yarn, strip, staple, and other forms of chopped, cut or discontinuous fibers and similar with regular and irregular cross-sections. The term “fiber” in each case also comprises several of the abovementioned objects or combinations thereof.

The at least one package of laminates is designated in the following as an antiballistically effective package or package due to its antiballistic properties. Despite the designation, antiballistically effective package, the package can also have stab-resistance properties.

The separate first protective sheath is also only called protective sheath in the following. Likewise, the second separate sheath is also only called sheath in the following. By designating the sheaths as separate and by listing of a first protective sheath and a second sheath it should be clear, however, that the protective sheath and the sheath are in each case two sheaths that are separated from each other. A coating of the protective sheath or of the sheath (complete or partial) should not be understood as an additional sheath.

The one-piece or multiple-piece knitted sheath can be designated in the following also as a one-piece sheath, as a multiple-piece sheath or simply as a sheath.

A one-piece sheath should be understood to mean that the sheath is only made from one piece and the production of the sheath does not require the joining of a plurality of sheath components. A one-piece sheath is already manufactured if the production is from only one piece. For example, a round-knitted tube is a one-piece sheath within the meaning of the invention. Preferably, a knitted tube is knitted in such a way that the tube has no, or rather only one, open edge (outlet). However, a knitted tube, which has two or more outlets in the form of open edges, should also be understood as one-piece within the meaning of the invention, if merely the open edges must be closed (for example by sewing up) to form the sheath. A sheath that is created in that two or more components are connected with one another should not be understood as one-piece within the meaning of the invention.

A multiple-piece sheath within the meaning of the invention consists of components which are joined to produce the multiple-piece sheath. For example, a sheath that consists of a front part and a back part, which are joined with one another, is a multiple-piece sheath within the meaning of the invention. A multiple-piece sheath can, for example, be produced from knitted piece goods, wherein the front part and the back part are cut out of the piece goods.

The protective sheath can consist of a water- and dirt-repellent and opaque material. The protective sheath should preferably protect the antiballistically effective material from moisture and sunlight. A UV opaque polymer film can, for example, be used as the material for the protective sheath.

Preferably the sheath consists at least partially of fibers with a tenacity of at least 900 MPa measured according to ASTM D-885.

In another embodiment it is preferred if the sheath consists at least partially of fibers with a tenacity of at least 1160 MPa measured according to ASTM D-885.

Further preferably, the sheath consists entirely of fibers with a tenacity of at least 900 MPa or the sheath consists entirely of fibers with a tenacity of at least 1160 MPa, particularly preferably, the sheath consists entirely or partially of fibers with a tenacity of at least 2500 MPa, more particularly preferably of at least 3000 MPa. The tenacity of the fibers is measured in each case according to ASTM D-885. If the sheath has, in addition to the fibers with the required minimum strength, still further fibers, it is preferable if the further fibers have a lower tenacity. By this means, the edge exit of a projectile can be advantageously prevented by using fibers with a high strength, the sheath, however, is still neither unnecessarily expensive or heavy due to the fibers with lower tenacity.

Preferably the sheath is essentially completely enclosed by the protective sheath. Thereby, the antiballistically effective package is preferably completely enclosed by the sheath. It is also self-evidently conceivable that the protective sheath is essentially completely enclosed by the sheath. That means that the antiballistically effective package and the protective sheath are essentially completely enclosed by the sheath.

An essentially complete enclosure should be understood as meaning that it encloses at least 80% of the surface of the object to be enclosed. Preferably however in a complete enclosure the entire surface of the object to be enclosed is enclosed.

The fibers for the sheath preferably consist of polyethylene, polypropylene, aromatic polyamide, polybenzoxazole, polybenzothiazole, polyester, polyamide, natural polymers, or natural fibers (such as e.g. cotton or linen). It is further conceivable that the sheath is produced from more than only one type of fiber or more than only one type of yarn.

The laminates are preferably formed of fibers that are among one or more of the groups of polyethylenes with ultra high molecular weight, polypropylenes with ultra high molecular weight, aromatic polyamides, polybenzoxazoles or polybenzothiazoles. An example for a yarn made of fibers made of polyethylene with an ultra high molecular weight is Spectra® or Dyneema®. An example for a yarn made of aromatic polyamide is Twaron®. It is of course possible that the laminates are produced from more than only one type of fiber or more than only one type of yarn.

The fibers for producing the sheath and the laminates are preferably available in the form of yarn. The yarns for producing the sheath and the laminates can be multifilament yarns, staple fiber yarns, or mixtures of multifilament and staple fibers.

The yarns preferably form a yarn layer in the laminate.

The yarns of the yarn layer are arranged preferably in a unidirectional structure in the laminates. A possible example for a yarn layer in a unidirectional structure is Twaron® LFT GF4, which is sold by Teijin Aramid GmbH. It is however also preferred, if the yarns in the yarn layer are arranged in a multidirectional structure, or if the yarns are arranged in the yarn layer as a woven. Of course, there can also be differently constructed laminates inside of the antiballistically effective package. For example, the package can be formed of laminates with unidirectionally arranged yarns in the yarn layer and of laminates with a woven fabric layer as the yarn layer. If the yarn layer in the laminates is formed by a woven fabric, then the Twaron® fabrics T 751, T 730, CT 716, CT 732, CT 714, CT 704, CT 707, CT 709, CT 612, CT 613, CT 615, CT 736, and/or T 750 from Teijin Aramid GmbH are preferably used. It is also conceivable that woven fabrics with additional layers can be used as a yarn layer, wherein the additional layer should not be the polymeric material.

The laminates preferably have a polymeric material on each side of the yarn layer. Of course, also only one side of the yarn layer can have a polymeric material, or the polymeric material can be arranged between two yarn layers. With regard to a polymeric material between two yarn layers, reference is made to document WO 00/008411 A1, which is hereby introduced as a reference and is therefore part of the disclosure. Preferably the polymeric material can be assigned to the group of thermoplastic polymers and/or elastomers and/or duromers. Mixtures of the cited polymeric materials are also conceivable. The polymeric material is, for example, laid or applied on the yarn layer in the form of a film and finally pressed with it into a laminate by means of heat and pressure. The polymeric material can however also be arranged in the form of a matrix, in which the yarns are embedded and which for example can be applied as a liquid coating completely or only partially on the yarns. Further it is possible that the yarns prior to the formation of the yarn layer are already coated with polymeric material, so that a further use of polymeric material is no longer inevitably necessary. The laminates are preferably constructed in the way as they are described in document EP 1 241 432 A1.Document EP 1 241 432 A1 is introduced as a reference and should be understood as part of the disclosure.

A polyethylene based copolymer, such as e.g. Candal® from Lorica Research Limited, or a polycarbonate can be used as the polymeric material.

The sheath preferably has a plurality of surface regions, wherein the surface regions preferably differ from one another. Particularly preferably, the surface regions differ from one another with regard to the present mass per unit area, the present elasticity, the yarns used, the yarn count of the yarns used and/or with regard to the weave used.

Further, the surface regions can also differ from one another with regard to the present mesh density. The surface areas can thus be formed with different characteristics inside of the sheath in an advantageous way.

The sheath preferably has a periphery and a central region, wherein the periphery encloses the edges of the antiballistically effective package. The periphery and the central region can form the different surface regions of the sheath. It is further preferred that all edges of the antiballistically effective package are essentially completely enclosed by the periphery of the sheath. For the essentially complete edge enclosure by the periphery, the periphery runs initially parallel to the primary extension plane of the laminate in a first direction, then essentially perpendicular to the primary extension plane of the laminate along the edges of the laminate and finally again parallel to the primary extension plane of the laminate opposite to the first direction. Consequently, the edges are completely hemmed by the periphery. In an advantageous way, this can prevent a projectile, in spite of an edge enclosure, from exiting out of a hole inside of the edge enclosure and injuring persons.

Preferably the periphery of the sheath has a higher mass per unit area and/or a greater elasticity than the central region of the sheath. The periphery can be, for example due to the yarn processed in it or due to the weave present in it, more stable, more elastic, and/or stronger than the central region of the sheath. It is also conceivable that stationary threads are worked into the periphery. It is further possible that the periphery has a higher number of stitch courses and/or wales in contrast with the central region. Due to these measures, only the surface region (periphery) of the sheath, which should prevent a lateral exit of the projectile, is correspondingly designed. The central region can be provided as less stable, less elastic and/or with a lower mass per unit area and thereby be easier and less expensively produced. It is however also conceivable, that the central region of the sheath has a higher mass per unit area and/or a greater elasticity than the periphery of the sheath.

The knitted textile fabric from which the sheath is produced can generally have a mass per unit area between 100 g/m² and 700 g/m². The mass per unit area is determined thereby preferably by means of a single-ply material sample, wherein the material sample has approximately equally as much periphery as central region. Further, the entire sheath or only the surface regions of the sheath can, for example, be produced from a multifilament yarn with a yarn count of 210 dtex to 3360 dtex.

Preferably the sheath has at least one opening, in which the antiballistically effective package can be inserted.

If the sheath has a plurality of outlets, which arise during the production of the sheath and which must be closed after production, then these are preferably sewed up. Connecting seams are created by sewing up such outlets. Preferably the closing of the outlets occurs in such a way that no connecting seams are created in the periphery of the sheath. For example, in the case of a multiple-piece sheath, the front part or the back part can be made longer, so that when closing the sheath the longer part is laid over the outlet and on top of the shorter part of the sheath. The longer part lies thereby preferably in the central region on the shorter part. The longer part of the sheath is then sewed to the shorter part in the central region, so that the connecting seam lies in the central region of the sheath.

In the case of a multiple-piece sheath, the components of the sheath can for example be connected with one another in the periphery. In the case of a one-piece sheath, the sheath preferably has no outlets. A sheath without outlets is thus a sheath which, even during manufacturing, is produced entirely without open edges. For example, a structure created by flat knitting can present a sheath without outlets, if all edges of the sheath are already closed by the flat knitting. A sheath of this type is provided with an opening after production, wherein the opening is provided for the insertion of the antiballistically effective package. This opening is not considered to be an outlet (for example an outlet opening) of the sheath. The opening can remain open after the insertion of the antiballistically effective package. If the opening should be closed, however, the opening can be sewn up or glued or the opening can be concealed or covered in a self-closing way by means of an overlapping region.

Preferably the sheath, and more preferably the periphery of the sheath is produced from yarns made of poly(p-phenylenterephtalamide), such as those sold for example under the trade name TWARON® by Teijin Aramid GmbH. The yarns have a tenacity of 3380 MPa according to ASTM D-885 and the yarn preferably has a yarn count of 550 dtex. If the periphery is produced from a different yarn than the central region, it would be conceivable that the central area is produced, in comparison with the periphery, from yarns with a lower strength and/or from yarns having a lower price. For example, the central region can consist of polyester yarns, cotton yarns, viscose yarns, or mixtures of the cited yarns.

The invention will subsequently be described in more detail by means of Figures.

### FIGURES

FIG. 1 shows schematically a one-piece sheath for an antiballistically effective package.

FIG. 2 shows schematically in cross-section a cut-out of an antiballistically effective package with a one-piece sheath.

FIG. 3 shows schematically a partial area of a mesh structure for a one-piece sheath.

FIG. 4 shows schematically a sheath with bullet holes.

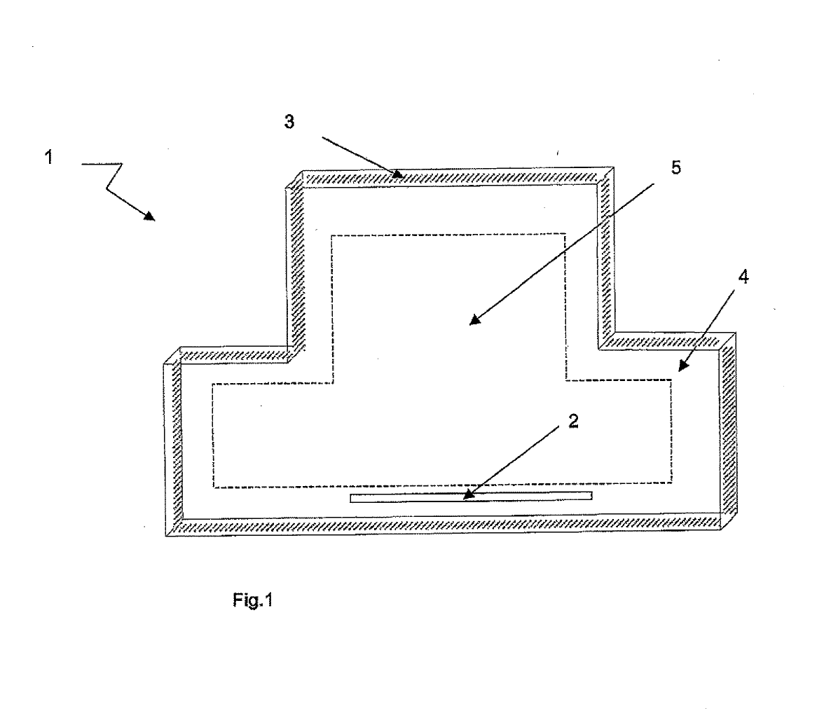

In FIG. 1, a sheath 1 for an antiballistically effective package 6 (not shown in FIG. 1) is schematically shown. The sheath 1 has a periphery 4 and a central region 5 which form the different surface regions of the sheath 1. The periphery 4 can for example have a higher stability or a higher elasticity, due to the fibers used or the weave present therein, than the central region 5. Because the central region 5 essentially does not have to have any antiballistic properties, the central region 5 can for example have a lower mass per unit area than the periphery 4 and can be produced from yarns that are not antiballistically effective. By this means, the sheath 1 is lighter as a whole and less expensive to produce. The periphery 4 can for example be 6 cm to 25 cm, particularly preferably 10 cm to 18 cm and more particularly preferably 13 cm to 15 cm wide. In the embodiment of FIG. 1, the sheath 1 is knitted in one piece, wherein in the regions 3 the loops are transferred to achieve a curve. By this means, a one-piece sheath 1 is created without producing outlet openings. To produce a sheath 1 without outlets, the sheath 1 can for example be produced on a flat knitting machine. For the production of a one-piece sheath 1 using a flat knitting machine, the front part and the back part of the one-piece sheath 1 are knitted in one work step. To connect the front part and the back part with one another, the loops in the region 3 are transferred. Alternatively to this, for a knitted sheath 1, the periphery 4 can be knitted in stockinette stitch. The sheath 1 preferably has an opening 2, through which the antiballistically effective package 6 is inserted in the sheath 1. The opening 2 can be closed after the insertion of the antiballistically effective package 6 for example by a seam or by gluing. An antiballistically effective yarn is preferably used as a sewing thread for this and the seam is kept as small as possible. It is particularly preferable, however, if the seam can be shifted into the central region 5. It is also however possible, to design the opening 2 in such a way that a sort of a lobe is formed on one side of the opening 2. This lobe can then, similar to the closure for an envelope, be inserted into the opening 2 or cover the opening 2 after the insertion of the antiballistically effective package 6. By this means, a self-closing closure of the opening 2 is created. The sheath can for example be produced completely from yarns made of poly(p-phenylenterephtalamide).

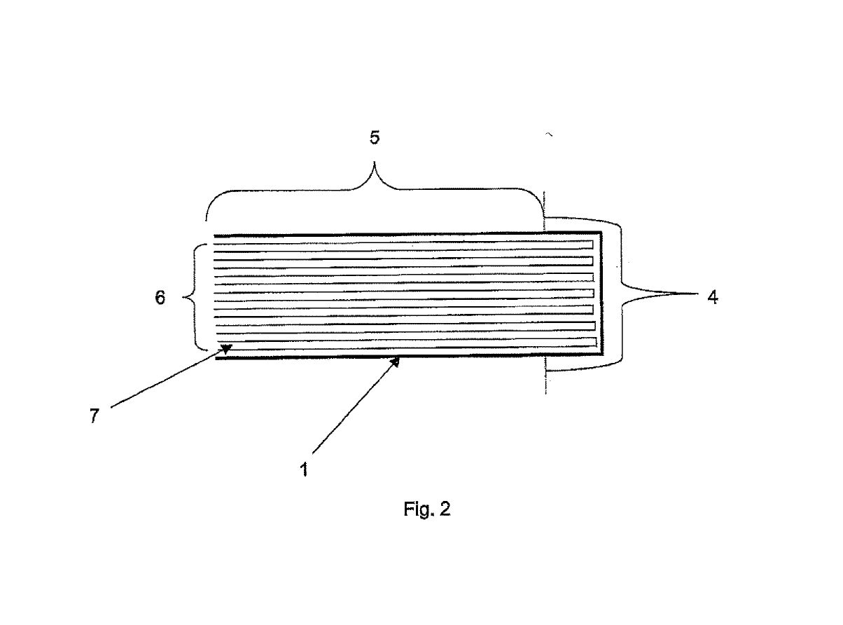

A cross-section of a part of an antiballistically effective package 6 with a part of an inventive sheath 1 is schematically shown in FIG. 2. The antiballistically effective package 6 consists of a plurality of laminates 7 superposed on one another inside of the antiballistically effective package 6. The laminates 7 are inserted in the self-contained sheath 1 through an opening 2, so that the laminates 7 and thereby the antiballistically effective package 6 are completely enclosed by the sheath 1. The periphery 4 of the sheath 1 thereby runs above and below the laminates 7 and along the edges of the laminates 7. The edge region of the laminates 7 is consequently hemmed by the periphery 4 of the sheath 1. Particularly preferably, all edge regions of the laminates 7 above and below the edges as well as along the edges are enclosed, or hemmed by the periphery 4 of the one-piece sheath 1. If a projectile slips away laterally, upwards or downwards on a laminate 7 of the antiballistically effective package 6, the projectile is detained by the periphery 4 of the one-piece sheath 1.

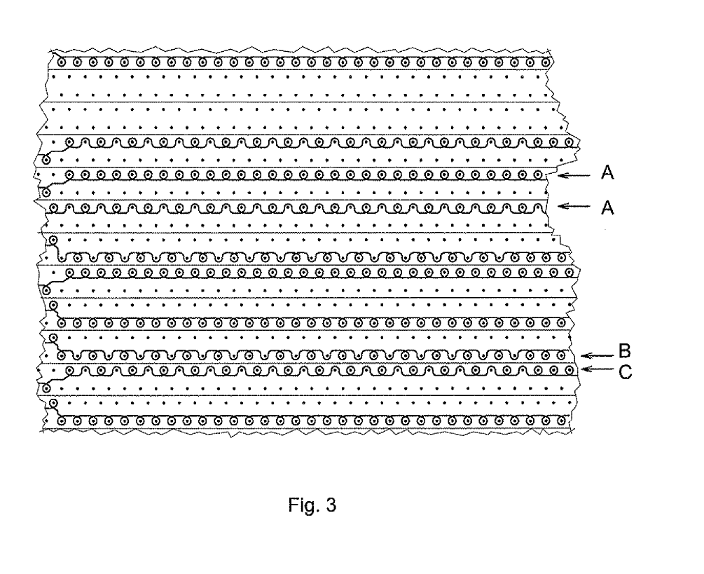

A cut out of a mesh structure for a one-piece sheath 1 is shown in FIG. 3. The cut out shown describes thereby the knitting pattern for a part of a periphery 4 of the sheath 1. A periphery of the back part A is produced by the combination of a stitch course comprising stitches and loops and a stitch course comprising only stitches. The row B describes as an example the production of the front part and the row C describes as an example the production of the back part, wherein the front part and back part of sheath 1 are produced on a flat knitting machine in one work step.

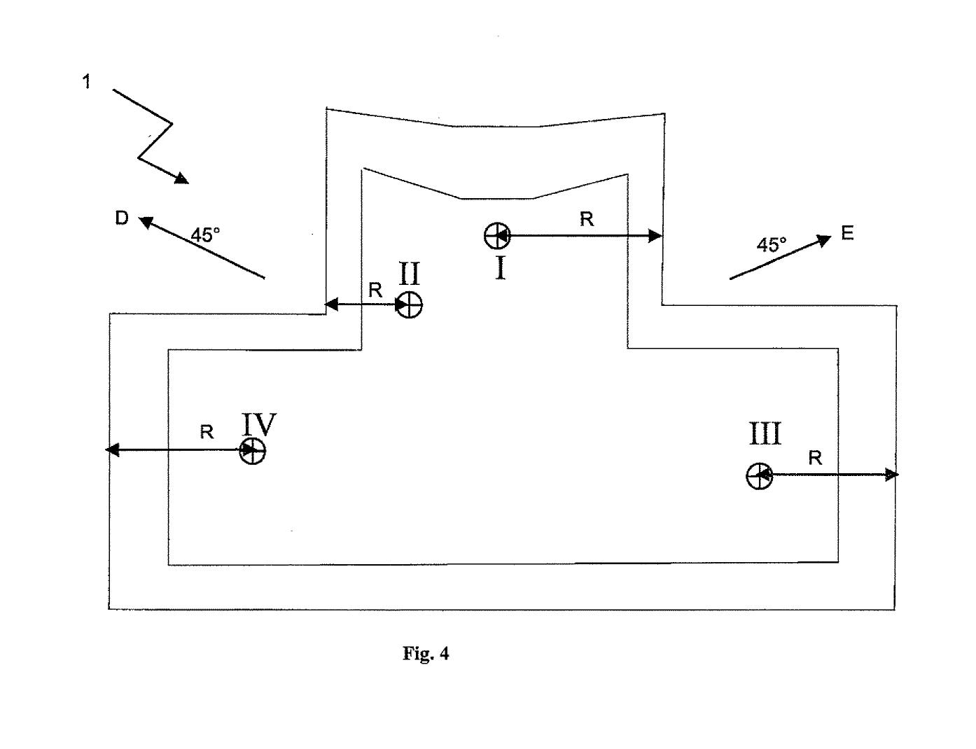

An antiballistically effective package 6 with a sheath 1 after a bombardment test is schematically shown in FIG. 4. The antiballistically effective package 6 and the sheath 1 were shot at four times, whereby each bullet hole I, II, III, and IV is indicated with a cross in a circle. The double arrows indicate in each case a distance R, wherein the distance R is the distance of a bullet hole from the edge of the sheath 1 or from the antiballistically effective package 6. Before the antiballistically effective package 6 is shot at, it is turned together with the sheath 1 from the position shown in FIG. 4 in the direction D or the direction E, wherein the angle of rotation is 45° (see on this Standard HOSDB, ballistic threat class HG 2). During bombardment tests that are supposed to lead to the bullet holes I and III, the antiballistically effective package 6 and the sheath 1 are turned in direction E. For bombardment tests to form the bullet holes II and IV, the antiballistically effective package 6 and the sheath 1 are turned in direction D.

The invention will be described in more detail in the following examples.

### EXAMPLES

The antiballistically effective packages, formed from laminates, were constructed identically in the bombardment tests and in the stab-resistance test, for the comparison examples as well as for the examples.

Each antiballistically effective package consisted of 26 superposed layers of “Pro-Tector” by the company TenCate. Pro-Tector consists of a para-aramide multifilament yarn 930 dtex f1000, type 2040, which is woven into a fabric (Twaron® CT 709, from Teijin Aramid GmbH), wherein a thermoplastic film, trade name Candal®, from Lorica Research Limited, is laminated to both sides of the fabric. The yarns for producing the fabric had a tenacity of 3380 MPa measured according to ASTM D-885. The fabric has a 1/1 plain weave, a mass per unit area of 200 g/m², and a thread count per cm of 10.5 in warp and weft directions.

### Example 1

For Example 1, the antiballistically effective package was placed in a one-piece, knitted sheath, wherein the antiballistically effective package was completely enclosed by the one-piece sheath. The yarn Twaron® 550 dtex f500, type 2040, from Teijin Aramid GmbH was used to produce the sheath. The yarn for producing the sheath had a strength of 3380 MPa measured according to ASTM D-885. The sheath was knitted using the programmable CMS 530 flat knitting machine from H. Stoll GmbH & Co. KG, wherein the loops were transferred to connect the front part of the sheath with the back part of the sheath. The periphery of the sheath was knitted in a combination of stitches and loops, as is shown in FIG. 3, and had a width of 13 cm and a mass per unit area of 395 g/m². The central region of the sheath had a right-left weave and a mass per unit area of 326 g/m². The antiballistically effective package was inserted into the sheath through an opening with a length of 20 cm. The opening lay in the periphery of the sheath and was ultimately not closed. The weight of the antiballistically effective package with the inventive sheath was 1193 g.

### Example 2

A sheath was produced according to that of Example 1 for the sheath according to Example 2, this sheath was then cut open in the periphery so that a front part and a back part were created. The front part and the back part were ultimately sewn up with one another again in the periphery, wherein two circumferential double lockstitch seams were used for this. An aramid yarn S840 dtex, f1000, type 2000, was used as the sewing thread. The weight of the sheath and the antiballistically effective package was 1411 g. The central region of the sheath had a mass per unit area of 326 g/m². The periphery of the sheath had a mass per unit area of 395 g/m².

### Example 3

The sheath for Example 3 was produced in one piece using a flat knitting machine according to the same method and in the same manner as for the sheath for Example 1. However, a blended yarn of 50% cotton and 50% polyacrylic with a linear density Nm28/2 was used as the yarn for the sheath. Yarns of this type are available for example from AS Schaefer Garne GmbH or WGF. The weight of the sheath and the antiballistically effective package was 1423 g. The total weight of the sheath was 133 g.

### Comparison Example 1

For the Comparison Example 1, the antiballistically effective package was completely enclosed by a comparison sheath. The comparison sheath comprised a sheath front part and a sheath back part, which were both cut from fabric layers. The sheath front part and the sheath back part were sewn together with one another using an aramid yarn 840 dtex f1000, type 2000, wherein two circumferential double lockstitch seams were used for this in the periphery. The fabric layers for the sheath front part and the sheath back part were produced from an aramid yarn 550 dtex f500, type 2040, using a rapier loom. The fabric layers for the comparison sheath had a 1/1 plain weave and a thread count of 110 per 10 cm in the warp and weft directions. Such fabric layers are known for example under the trade name CT 612, from Teijin Aramid GmbH. The weight of the comparison sheath with the antiballistically effective package was 1339 g. The comparison sheath had no central region and no periphery with different properties.

### Comparison Example 2

The antiballistically effective package was constructed for Comparison Example 2 like the antiballistically effective packages for the Examples and Comparison Example 1. The antiballistically effective package for Comparison Example 2 was however not enclosed by a sheath or by a comparison sheath.

The antiballistically effective packages were inserted for the Examples and for Comparison Example 1 through an opening in the sheaths or in the comparison sheath respectively, wherein the antiballistically effective packages were completely enclosed by the sheath or by the comparison sheath respectively. For the Examples, the openings were located in the sheaths 3.5 cm from the lower fold edge of the periphery. For the comparison sheath, a portion of the seam for connecting the front part and the back part was left open in order to be able to insert the antiballistically effective package. This portion of the seam was closed by sewing after the insertion of the antiballistically effective package and prior to shooting the package.

The antiballistically effective packages with the respective sheaths according to the Comparison Example 1, the examples, and the antiballistically effective package according to Comparison Example 2 were shot at according to the British Standard HOSDB, class HG 2 from a distance of 5 m. All antiballistically effective packages were fired at in such a way that the bullet holes I, II, III, and IV were created, wherein—as is specified in the description for FIG. 4—the antiballistically effective package and the sheath were turned accordingly in the D or E directions. A 5 mm foam layer, from Alanto Limited, product name Protect-a-cell 1 vinyl nitril was positioned on the side of the laminates facing away from the side being shot at and inside of the sheath for the comparison example as well as for the examples. The resulting trauma behind the antiballistically effective packages and the sheaths was determined by means of a Roma plasticine block, which was likewise located on the side of the laminates facing away from the side being shot at, but outside of the sheath. The bombardment tests were conducted for the examples and for the comparison example at an angle of 45°.

### Bombardment Test 1

Caliber: 9 mm Para
Ammunition: VMR/DM11

TABLE 1

| | | R (distance | |
|---|---|---|---|
| | | of the entry | |
| | | point of the | |
| | | projectile to | |
| | V | the edge of the | End location of |
| | (m/s) | sheath) (cm) | bullet |
| Example 1 | 424 | 11 | Sheath |
| Example 1 | 428 | 11 | Sheath |
| Example 1 | 425 | 11 | Sheath |
| Example 1 | 420 | 11 | Sheath |
| Example 2 | 420 | 11 | Sheath |
| Example 2 | 425 | 11 | Sheath |
| Example 2 | 427 | 11 | Sheath |
| Example 2 | 422 | 11 | Sheath |
| Example 3 | 423 | 11 | Sheath |
| Example 3 | 421 | 12 | Exit from the sheath |
| Example 3 | 424 | 11 | Exit from the sheath |
| Example 3 | 425 | 12 | Sheath |
| Comparison Example 1 | 430 | 11 | Exit from the sheath |
| Comparison Example 1 | 421 | 11 | Exit from the sheath |
| Comparison Example 1 | 424 | 11 | Exit from the sheath |
| Comparison Example 1 | 423 | 11 | Exit from the sheath |
| Comparison Example 2 | 429 | 11 | Exit from the package |
| Comparison Example 2 | 421 | 11 | Exit from the package |
| Comparison Example 2 | 423 | 11 | Exit from the package |
| Comparison Example 2 | 431 | 11 | Exit from the package |

It is clear from Table 1, that a one-piece or multiple-piece sheath can prevent an exit from the periphery, if the one-piece or multiple-piece sheath is knitted. It is particularly clear from Example 3, that even when using essentially yarns that are not antiballistically effective to produce a knitted sheath, a lateral projectile exit from the sheath, and therefore from the penetration-resistant article can be prevented in at least 50% of the cases. A sheath made from antiballistically effective yarns, which however was produced by sewing two fabric layers together (Comparison Example 1), can, on the contrary, not prevent the peripheral exit of a projectile. Comparison Example 2 should make clear that, for a shot fired at an angle of 45° at a laminate package as an antiballistically effective package, the projectile will exit laterally from the antiballistically effective package. Without the inventive sheath for the antiballistically effective package, the projectile also then exits from the penetration-resistant article, which results in a risk of injury to the wearer or to persons standing in close proximity.

### Bombardment Test 2

Caliber: 0.357 Magnum
Ammunition: TMF/REM

The ammunition used in Bombardment Test 1 is generally less strongly deformed from impacting and penetrating the laminates than the TMF/REM type of ammunition (Bombardment Test 2). Thereby, the risk of a lateral exit of the projectile from the antiballistically effective package is greater than for the type of ammunition used in Bombardment Test 2. Based on this knowledge and the fact that a knitted sheath has already held back the less strongly deforming type of ammunition, it was decided to forego a shot using the TMF/REM ammunition at the packages with the sheath according to Examples 2 and 3. Therefore, in Bombardment Test 2, only a package with a sheath, constructed according to Example 1, and a package with a comparison sheath—as described in Comparison Example 1—were shot at.

TABLE 2

| | | R (distance | |
|---|---|---|---|
| | | of the entry | |
| | | point of the | |
| | | projectile to | |
| | V | the edge of the | End location of |
| | (m/s) | sheath) (cm) | bullet |
| Example 1 | 456 | 11 | Sheath |
| Example 1 | 451 | 11 | Sheath |
| Example 1 | 449 | 11 | Sheath |
| Example 1 | 452 | 11 | Sheath |
| Comparison Example 1 | 442 | 11 | Exit from the sheath |
| Comparison Example 1 | 442 | 11 | Exit from the sheath |
| Comparison Example 1 | 447 | 11 | Exit from the sheath |
| Comparison Example 1 | 448 | 11 | Exit from the sheath |

In Bombardment Test 2 as well, the shots penetrated several of the laminates, then slid along the laminates and were stopped by the one-piece, knitted sheath (Example 1). A peripheral exit of the projectile could therefore be prevented, when using this type of ammunition as well, for all bombardment tests by the one-piece, knitted sheath. When using a woven sheath, on the contrary, the projectile could not be stopped, it penetrated the comparison sheath (Comparison Example 1) and exited from the penetration-resistant article. Despite the use of an antiballistically effective yarn to produce the comparison sheath, a peripheral exit by the projectile and therefore an injury to persons thus cannot be prevented by a woven comparison sheath.

During the bombardment tests for an angle shot, the projectiles initially penetrate the sheaths and several of the laminates, whereby the kinetic energy of the projectiles is reduced and they are consequently slowed down. If their kinetic energy is too low to penetrate a further laminate, then the projectiles slide along the laminate. The inventive sheath is designed in the periphery so that such a projectile can be caught or stopped. By this means, the projectile remains within the inventive sheath and therefore within the antiballistically effective package.

### Stab-resistance Test

An article, constructed as in Example 1, and an article, constructed as in Comparison Example 2 (that is, without a sheath), were tested for their stab resistance, wherein the test took place according to the British Standard HOSDB. The protection class to be examined was KR 1. The stab resistance was tested using a knife, wherein the knife fell with an energy of 36 Joule on the antiballistically effective package with sheath (Example 1) and respectively without sheath (Comparison Example 2). A 5 mm foam layer, from Alanto Limited, product name Protect-a-cell 1 vinyle nitrile was positioned on the side of the laminates facing away from the side being threatened in Example 1 and in Comparison Example 2. The foam layer was positioned inside of the sheath in Example 1. Table 3 lists the penetration of the article according to Example 1 and according to Comparison Example 2.

TABLE 3

| | Example 1 | Comparison Example 2 |
|---|---|---|
| Penetration (mm) | 7 | 10 |
| | 2 | 13 |
| | 0 | 13 |
| | 4 | |

It is clear from Table 3, that the sheath, constructed as described in Example 1, leads to an improvement of the stab-resistance properties of an article. It was completely surprising to a person skilled in the art and not to be expected that a knitted sheath can prevent the exit of projectiles from an article as well as improve the stab-resistance properties of the article. Because the sheath decreases the penetration of the article in comparison with an article without a sheath, it is conceivable that the package of laminates for a comparable stab resistance would require fewer laminate layers than would be necessary for an article without a sheath. By this means, the weight of the package and thereby the weight of the article can be advantageously reduced.

### LIST OF REFERENCE NUMERALS

1 Sheath
2 Opening
3 Regions
4 Periphery
5 Central region
6 Antiballistically effective package
7 Laminate
A Periphery of the back part
B Course
C Course
D Direction
E Direction
R Distance (of the entry point of the projectile to the edge of the antiballistically effective package)
I, II, III, IV Bullet hole

1. A penetration-resistant article comprising at least one package of laminates comprised of:
at least one layer comprising fibers with a tenacity of at least 2000 MPa, and
at least one polymeric material,
wherein the at least one package is enclosed by a first sheath,
wherein the at least one package is essentially completely enclosed by a second sheath,
wherein the first sheath and the second sheath are separate from each other, and
wherein the second sheath is a one-piece knitted sheath or a multiple piece knitted sheath.

2. The penetration-resistant article according to claim 1, wherein the second sheath comprises at least partially fibers with a tenacity of at least 900 MPa.

3. The penetration-resistant article according to claim 1, wherein the second sheath comprises at least partially fibers with a tenacity of at least 1160 MPa.

4. The penetration-resistant article according to claim 1, wherein the second sheath is essentially completely enclosed by the first sheath.

5. The penetration-resistant article according to claim 1, wherein the fibers in the laminates are arranged in a unidirectional structure.

6. The penetration-resistant article according to claim 1, wherein the fibers in the laminates are arranged in a multidirectional structure.

7. The penetration-resistant article according to claim 1, wherein the fibers in the laminates are arranged as a woven structure.

8. The penetration-resistant article according to claim 1, wherein the fibers in the laminates are selected from the group consisting of polyethylenes, polypropylenes, aromatic polyamides, polybenzoxazoles, and polybenzothiazoles.

9. The penetration-resistant article according to claim 1, wherein the fibers of the second sheath are selected from the group consisting of polyethylenes, polypropylenes, aromatic polyamides, polybenzoxazoles, polybenzothiazoles, polyesters, polyamides, natural polymers, and natural fibers.

10. The penetration-resistant article according claim 1, wherein the polymeric material is a thermoplastic polymer, an elastomer, a duromer or mixtures thereof.

11. The penetration-resistant article according claim 1, wherein the second sheath has a plurality of surface regions, the surface regions being different from one another.

12. The penetration-resistant article according to claim 11, wherein the plurality of surface regions are different from one another with regard to at least one of:
present mass per unit area,
present elasticities,
yarns used to form the plurality of surface regions, yarn count of yarns used to form the plurality of surface regions, and
weaves used to form the plurality of surface regions.

13. The penetration-resistant article according to claim 1, wherein the second sheath has a periphery that encloses edges of the at least one package.

14. The penetration-resistant article according to claim 1, wherein the second sheath has a central region.

15. The penetration-resistant article according to claim 1 wherein the second sheath has at least one opening such that the at least one package (6) can be inserted into the at least one opening.
